(19) United States
(12) Patent Application Publication
(10) Pub. No.: US 2009/0182639 A1
(43) Pub. Date: Jul. 16, 2009

(54) SHIPPING STATION AND LOGISTICS SYSTEM

(76) Inventor: Brian Johnson, Surprise, AZ (US)

Correspondence Address: International IP Law Group, P.O. BOX 691927, HOUSTON, TX, 77269-1927, US

(21) Appl. No.: 12/163,035

(22) Filed: Jun. 27, 2008

Related U.S. Application Data
(60) Provisional application No. 60/937,703, filed on Jun. 29, 2007.

(51) Int. Cl. G06Q 20/00

(52) U.S. Cl. 705/17; 705/23; 705/21

(57) ABSTRACT

An exemplary embodiment of the present invention relates to a shipping station. An exemplary shipping station includes a shipping pad that is placed at a cash register. The invention further relates to a logistics system.

### CROSS-REFERENCE TO RELATED APPLICATION

This application claims priority of U.S. Provisional Patent Application Ser. No. 60/937,703, filed Jun. 29, 2007 entitled “Shipping Station and Logistics System” by Johnson, the contents of which are incorporated by reference as though fully set forth herein.

### BACKGROUND

Exemplary embodiments of the present invention relate to a shipping station which allows a user to deposit shipments into a logistics system. The shipping system allows accepting a shipment from a user so that it can be forwarded to a destination.

Several types of shipping stations are known. These shipping stations are, for example, post offices which allow a user to deposit an item for shipping, electronic parcel systems or drop boxes.

### SUMMARY OF THE INVENTION

An exemplary embodiment of the present invention relates to a shipping station having shipments, whereby usability for users is increased. Furthermore, safeguards against fraudulent use during the handling of shipments are provided.

Exemplary embodiments of the present invention may include a shipping station having a shipping pad placed at a cash register.

This allows integration of a shipping of items in a retail process for selling the item to a user. The user gets the additional functionality of being allowed to easily ship an item purchased at a retail center, such as a supermarket.

In order to facilitate the operation of a shipping station in accordance with an exemplary embodiment of the present invention, the shipping pad may be capable of reading information from a key tag.

The key tag could contain information about the user and/or about desired shipment information, for example, accounting information.

In one exemplary embodiment of the present invention, the key tag contains credit card information.

In order to facilitate printing of waybills, labels and/or invoices, the shipping pad may be connected to a printer.

An exemplary embodiment of the present invention may provide a method for operating a shipping station, for which at least one user is also able to deposit shipments, whereby the method comprises depositing of a shipment from a user so that it can be forwarded to a logistics service provider.

A method according to an exemplary embodiment of the present invention may comprise the following steps:
acquiring data about a user and/or shipping preferences of the user by a first acquisition means separated from the shipping station, and
acquiring shipment information for items at the shipping station.

The items are disposed in a suitable retail location, e.g. a supermarket. In order to facilitate a shipping of items, the shipping pad may be placed at the cash register of a retail facility.

In one exemplary embodiment of the present invention, a first acquisition device is connected to the internet. A second acquisition device may comprise a terminal located at the shipping station.

Information acquired at the first acquisition device may be stored in a key tag.

Data about the intended shipment that is acquired by the first acquisition device may include information about intended deliveries.

Information about an intended shipment may contain an indication of items intended for shipment.

In one exemplary embodiment of the present invention, the key tag may be scanned at the shipping station.

The shipping station may include a display. The display may be adapted to display information about pre-entered items.

One exemplary embodiment of the present invention relates to acquiring user data of a user at a first acquisition device separated from the shipping station.

### BRIEF DESCRIPTION OF THE DRAWINGS

FIG. 1 is a perspective view of a shipping station in accordance with an exemplary embodiment of the present invention;

FIG. 2 is a block diagram of a logistics systems having a shipping station in accordance with an exemplary embodiment of the present invention;

FIG. 3 is a diagram showing a key tag in accordance with an exemplary embodiment of the present invention;

FIG. 4 is a diagram of a shipping system in which a shipping pad is disposed at a cash register in accordance with an exemplary embodiment of the present invention;

FIG. 5 is a diagram of a printer that is adapted to print a label that can be attached to a package for use in a delivery process in accordance with an exemplary embodiment of the present invention; and

FIG. 6 is a diagram showing a hand over of a shipment from a user to an associate of a retailer using the shipping station 10 in accordance with an exemplary embodiment of the present invention.

### DETAILED DESCRIPTION OF SPECIFIC EMBODIMENTS

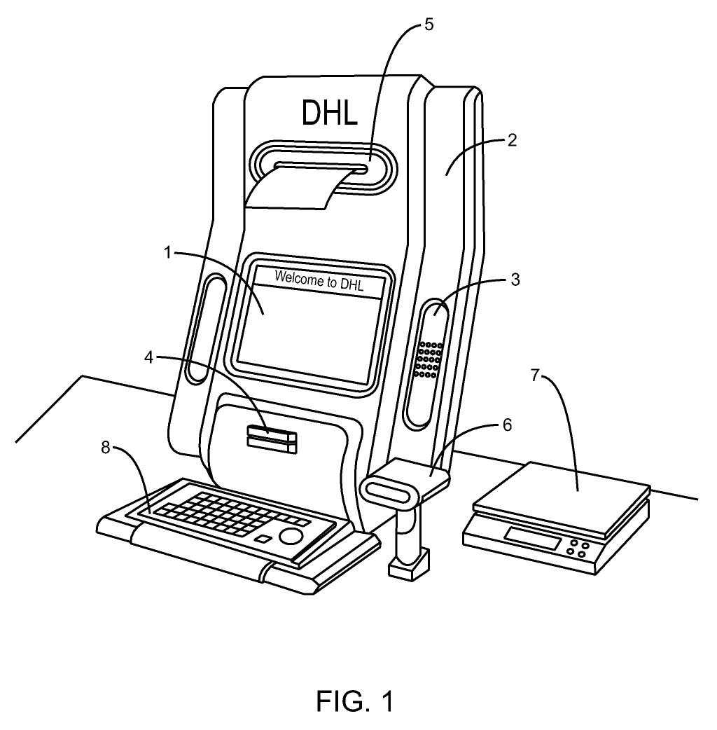

FIG. 1 shows a shipping station with a terminal. This terminal contains a display 1. The display 1 is e.g. a flat screen, e.g. an LCD monitor. It is possible to use a standard monitor, e.g. a standard 17 inch LCD monitor with a touch screen.

The terminal 2 is made of an appropriate material, e.g. a material which is capable of protecting the interior of the station from external influences. It is therefore especially useful that it consists of durable material, e.g. plastic material e.g. polycarbonate.

In order to facilitate a communication with a service station of a logistics system provider, the shipping station contains a speaker phone 3.

For carrying out payment procedures it is advantageous, that the shipping station contains a credit card reader 4.

Labels, waybills, or other items to be printed are printed by a printer 5. Advantageously the printer 5 is implemented in the terminal. The printer is e.g. a Thermal Label Printer.

In one exemplary embodiment of the present invention, a scanner is combined with the shipping pad. The scanner is e.g. a one-dimensional (bar code) a two-dimensional (matrix code) scanner or a RFID reader. The scanner is enabled to read coded information, e.g. information about items to be shipped.

In an advantageous exemplary embodiment of the present invention, the cash register 6 and the shipping pad are connected through a data link. The data link is configured in a way that information about board items are transferred from the cash register to the shipping pad.

This facilitates the shipping process. Especially it is possible to transmit the information about the items.

For example it is possible to announce a shipment to a receiver.

It is furthermore possible to use information about board items to be shipped in to the logistics system. This allows, for example, to calculate transport fees—e.g. with respect to a size or a weight of the item.

It is furthermore possible to adapt transport parameters to the kind of goods to be shipped. For example it is possible to integrate shock-resistant package to protect fragile items.

A scale 7 allows a weighing of items to be shipped. The scale and the shipping pad are connected via an appropriate data link. This data link can be carried out by wire or a wireless solution. A preferred embodiment of a wireless solution is bluetooth.

To facilitate a choice of options, the shipping station contains a keyboard 8.

A preferred embodiment of the invention is afterwards called Shop N Ship. This preferred embodiment is characterized in that the shipping station is integrated in a retail facility.

Shop N Ship is designed as a convenience for retail users that want to ship their recent purchases. The concept is simple. A user shops at his local retailer and brings his purchase to the check-out counter. If he wishes to ship his purchase he would use the shipping pad and his purchase would be packed and shipped by the cashier or other representative.

This process eliminates the need for a user to have to box, wrap, tape or pack his product and then find a local shipper. It also has the added benefit of making the local retailers a convenient shipping portal for anyone who needs to ship a package.

For users to utilize the service, a web registration is necessary but once completed, users could use the service at any retailer. A small touch-pad is placed at the register and connected to a small printer. When a user signs in and selects his consignee, a waybill is printed and his credit card is billed and package prepared.

Data can be sent via cellular connection or internet if available.

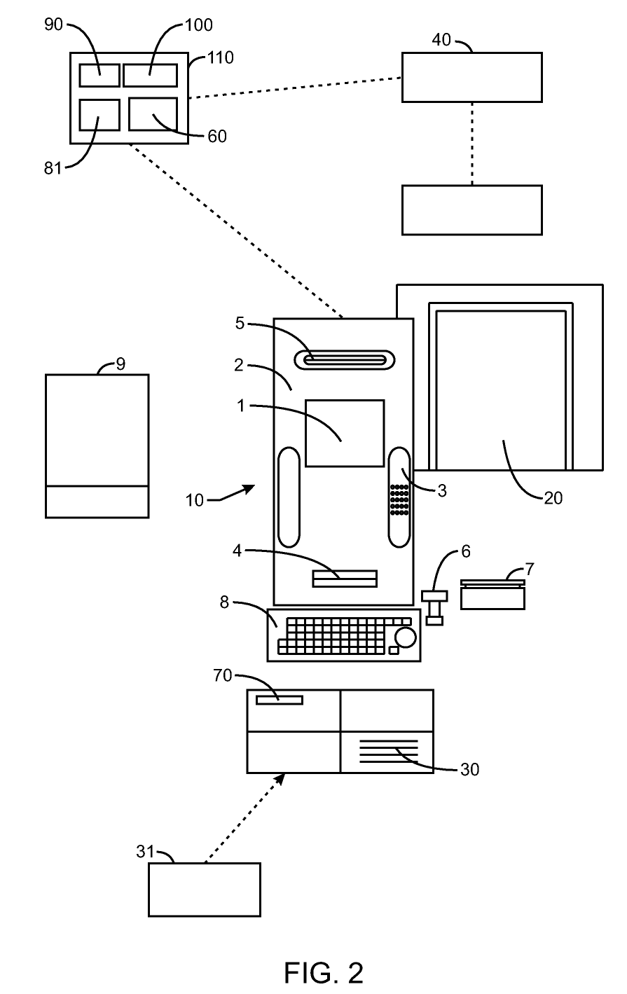

FIG. 2 shows a schematic depiction of an electronic shipping station 10 with its associated components and users. The shipping station 10 can especially be used by several users 31 and by one or more logistics service providers 40. The shipping station 10 is located close to a cash register 9.

First acquisition means 50 are placed outside the shipping station. They are e.g. a computer terminal which can be connected to the internet.

Second acquisition means 80 are integrated in the shipping station.

The shipping station can be integrated in a logistics system.

The logistics system is a logistics system in its broadest sense. The logistics system especially includes systems, which contain means and/or arrangements for carrying out the transport and/or handling of items. These items are shipped from the shipping station to a destination. They are therefore also called shipments.

This especially encompasses a transport of items—especially of postal deliveries—from a starting point to a destination along a transport route.

The logistics system could comprise several types of shipping stations.

Examples of the shipping station are: an electronic parcel compartment system, a drop box or a terminal which could be combined with the electronic parcel compartment system, a drop box or post office counter.

The first acquisition means (50) is for example a computer means which could be connected to a data network.

The data network is for example the internet.

In the method shown, the user would like to send shipment 30 to a receiver via a logistics service provider. The user/recipient might originally have received the shipment by having picked it up at a shipping station or through a regular shipping at his home address. In this context, such a shipment is referred to as a return shipment.

In order for the user 31 to access the operating functions at the shipping station, he normally has to identify himself at operating means of the system. This can be done by entering a PIN code or some other access code. In an especially preferred embodiment, the entry of access data can be augmented or replaced by inserting a user card.

The user data is acquired in a first acquisition means 50 which, depending on the type of data acquisition, can be, for instance, a card reader, a keyboard and/or a touch screen and/or a scanner.

It is possible to place the first acquisition means outside the shipping station. This allows to register user data early and to facilitate a registration of the shipments at the shipping station.

However, it is also possible to integrate the first acquisition means in the shipping station.

If the first acquisition means are sterically separated from the shipping station it is nevertheless possible that they are electronically connected with the shipping station, e.g. through the internet.

However, it is also possible that no connection between the first acquisition means and the shipping station exists.

In this case it is preferred, that information acquired at the first acquisition means is stored in a key tag.

This key tag allows a facilitated exchange of information at the shipping station and therefore accelerates a procedure of registering the shipments.

It is especially preferable to acquire user data by the first acquisition means.

The acquired user data is associated with a user profile and the associated access rights of the user are verified in a verification means 60 belonging to the shipping station. The verification means 60 can be located within the shipping station or can be connected to the system, for example, online. The online connection can be permanent or it can exist only while procedures are being carried out at the shipping station.

In the embodiment shown in FIG. 2, the verification means 60 is located in a central management unit 110 that preferably manages information for several shipping stations. The information is advantageously stored and managed in a database 90. In addition to user profiles, the managed information can also include data relating to logistics service providers and status data about the shipping stations.

In an especially preferred embodiment, the central data processing unit 110 also has a notification component 100 that serves to transmit messages between the shipping station, the central data processing unit, users and/or logistics service providers. The notification component sends users and logistics service providers, for example, automated messages via SMS or e-mail about deposited shipments.

If the verification of a user profile indicates that the user is authorized to have access and is permitted to use functions for the acceptance of returns, then the applicable operating functions are offered to him. This is done, for example, via instructions on the display means such as a monitor. If the verification ascertains that the user is not authorized to have access or is not permitted to use the return function, then the procedure is terminated and preferably a message is displayed to the user. As an alternative, the functions to which the user has access can be displayed without an explanatory message.

According to an exemplary embodiment of the present invention, in order to deposit a return shipment 30, the appertaining shipment information 70 has to be acquired first. This information is present in the form of an imprint, a sticker or a transponder (RFID) on the return shipment. The shipment information can be generated, for example, by a numeric string or a barcode. The acquisition is carried out by means of a second acquisition means 80 which can be, for instance, a scanner. If the shipment information is formed by a numeric string, this numeric string can also be entered by the user using an input means such as a keyboard or a touch screen.

The validity of the acquired shipment information is verified by a comparison with the stored information. The data and also the appertaining verification means 60 can be arranged within the shipping station or in the central data processing unit. The verification can be carried out, for example, on the basis of the number of digits and/or on the basis of a checksum logic. If the verification shows that the shipment information is invalid, the procedure is terminated and a message to this effect is displayed to the user. Invalid shipment information is present, for example, if incorrect data formats were acquired, which is an indication of an attempted fraudulent use of the return function. Moreover, if a logistics service provider withdraws from the shipping station, this could be a case of obsolete shipment information that no longer allows returns of the original shipment.

If the verification indicates that the acquired shipment information is valid and can be associated with a logistics service provider, then a compartment 20 is released for depositing the return shipment and it is closed after the shipment has been deposited there. A compartment can be selected, for example, as a function of the size of the shipment. If the payment of an additional sum is required in order to deposit the returns, then payment verification can be carried out before a compartment is opened. This is possible, for example, by reading in payment information such as stamps or value coupons on the shipment. Payment functions such as coin slots, reading means for cash cards, credit cards, Euro-check cards or reading means via cell phones can be provided in order to transact the required payments.

The acquired shipment information is stored in a storage means 81. The storage means can likewise be located within the shipping station or in the area of the central data processing unit 110. If the storage means is in the central data processing unit, as shown in FIG. 1, the shipment information is associated with the shipping station in question. Moreover, the information is associated with a logistics service provider. This is necessary for notifying the logistics service provider and/or for displaying a return when a deliverer of the logistics service provider logs in.

In an especially preferred exemplary embodiment of the present invention, a message is transmitted by the notification component 100 to a logistics service provider 40 indicating that a user has deposited a return shipment for him to pick up. In addition to information about the shipment and about the user, this message can also contain information about the time of the deposit and/or about the size of the shipment. Preferably, several messages about deposited returns are bundled in a collective message. This can be done, for example, at fixed intervals such as days or weeks.

In another exemplary embodiment of the present invention, the logistics service provider 40 does not receive a message about deposited returns but rather, when a deliverer logs in at the shipping station, a display tells him whether there are any return shipments for him in compartments of the system. These two embodiments can also be combined so that, in addition to a previously sent message, a display is also shown to the logistics service provider at the shipping station.

In order to remove a return shipment from a compartment, a deliverer normally has to identify himself at the shipping station. During or after the removal of a return shipment, the shipment information present on the shipment is preferably acquired once again and compared to the information stored in the storage means 81. If the shipment code format is not valid or if the acquired shipment information does not match shipment information stored for the shipping station in question, this means that, at the time when the shipment was deposited, a user caused shipment information to be acquired that was not on the shipment in question. In order to prevent such fraudulent use, the procedure is terminated and an operating function is displayed to the deliverer that allows him to readdress the shipment to the user. Preferably, he is offered the possibility to select the reason for readdressing the shipment or to enter this himself.

In case of a negative comparison of the shipment information, the deliverer places the shipment back into the compartment and the user 31 is preferably notified by the notification component 100 that he should remove the shipment. The user can also receive a direct notification (e.g. via e-mail or SMS) from the logistics service provider. It has proven to be advantageous to provide functions by means of which a user may not deposit any more shipments into the shipping station or remove any shipments from it as long as he has not removed a shipment that has been readdressed to him. Moreover, readdressing the shipment can have the consequence that the user profile in the data processing unit 110 is changed to indicate that the right of this user to deposit return shipments has been withdrawn.

An exemplary embodiment of the present invention includes different ways for allowing a user access to functions of the shipping station.

Then the access rights of the user are verified in a verification means belonging to the shipping station, by associating the acquired user data with a stored user profile.

In a preferred embodiment the information is stored in a key tag.

The procedure at the shipping station is terminated if the verification means yields a negative result of the verification. If the verification means yields a positive result of the verification, then access is granted to operating functions at the shipping station. Here, a distinction can be made between general operating functions of the shipping station and special operating functions for handling shipments. For example, all of the functions except depositing the item as shipment and/or creating labels of can be displayed and made available to the user if the verification of the user data has shown that the user in question does not have return rights.

The method also provides for a second acquisition means to acquire shipment information pertaining to a shipment. The shipment information is preferably present in the form of a label or key tag. The validity of the acquired shipment information is verified in a verification means belonging to the shipping station by comparing the acquired shipment information to stored data. Moreover, the shipment information is associated with a logistics service provider.

If the comparison of the acquired shipment information with stored data yields a negative result, the procedure is terminated, whereas if the comparison of the acquired shipment information with stored data yields a positive result, a shipping function is enabled—to allow a shipment of the item—so that the shipment can be deposited and the acquired shipment information is stored in a storage means. After a shipment has been deposited, the compartment is closed and a notification indicating that a return shipment has been deposited is transmitted by means of a notification component belonging to the shipping station to the logistics service provider with which the acquired shipment information was associated.

Preferably, a deposited shipment is displayed at the shipping station when the logistics service provider logs in. During or after the removal of a return shipment from a compartment of the shipping station by a deliverer, the shipment information is once again acquired by the second acquisition means and compared by a verification means to the shipment information stored in the storage means, after which the procedure is continued if the data matches, whereas it is terminated if the data does not match, and the deliverer is offered an operating function by means of which the return shipment can be readdressed to the user. This operating function preferably comprises entering the reasons for readdressing the return shipment to the user. In an especially preferred exemplary embodiment of the present invention, the notification component then notifies the user that a return shipment has been readdressed to him.

In an especially preferred exemplary embodiment of the present invention, the shipment information is a multi-digit numerical code. The validity of the shipment information can be verified on the basis of the number of digits and/or on the basis of a checksum logic stored in the verification means. Preferably, a fixed set of numbers is associated with each logistics service provider so that, on the basis of the acquired shipment information, the appertaining logistics service provider can be associated with a return.

It has proven to be advantageous for the notification component to transmit a notification to the logistics service provider comprising information about several return shipments that have been deposited for him. These notifications can be issued, for example, at fixed intervals such as days or weeks so that the logistics service provider receives a message indicating how many shipments and what type of shipments have to be removed at the time of the next login into a given shipping station.

It is also advantageous for the user data to be read in from a user card in the first acquisition means. The data can also be entered by the user via an acquisition means. The second acquisition means is preferably configured in such a way that it scans in the shipment information.

The method according to an exemplary embodiment of the present invention may provide several advantages. For one thing, such an exemplary embodiment may allow the verification of user profiles before a shipment is deposited, which further safeguards the operator of the shipping station against fraudulent use. If a user is not authorized to deposit return shipments, then this particular operating function is not offered to him.

Secondly, the security of the handling of returns is enhanced in that the shipment information is acquired and evaluated at the time of the deposit by the user as well as at the time of the pick-up by the deliverer of a logistics service provider. Hence, a user may only deposit shipments that are provided with a permissible shipment code of a logistics service provider. The shipment code is once again acquired at the time of the pick-up so as to prevent a user from previously causing an incorrect shipment code to be acquired. Since the data is once again compared, cases of fraudulent use are avoided where, at the time of the deposit, a user causes shipment information to be acquired that is not present on the deposited shipment.

Through the association of shipment information with specific logistics service providers, it becomes possible to allow several deliverers to be involved in the operation of a shipping station without compromising the security of the operator against fraudulent use of the system. It is also possible to integrate several users with different access rights.

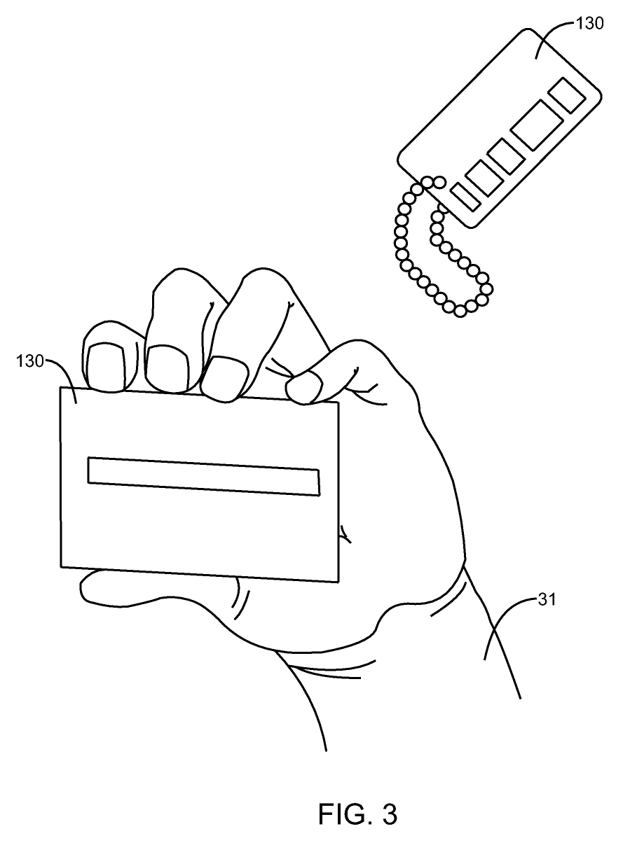

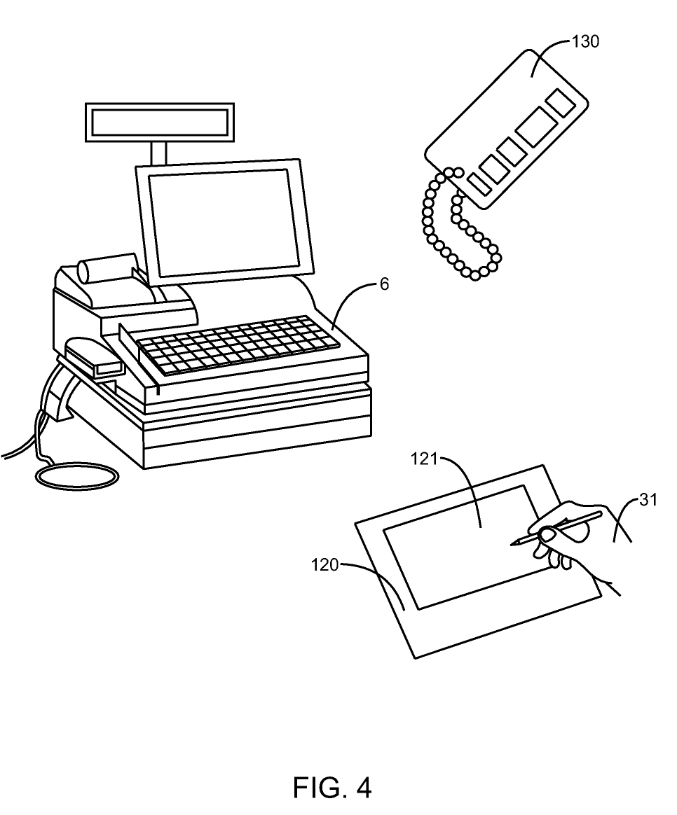

An especially preferred exemplary embodiment of the present invention is afterwards described according to FIGS. 3, 4 and 5.

FIG. 3 shows a key tag which contains information which can be read by a suitable reader, for example at a cash register 9 or a shipping pad 120.

The key tag is pre-programmed by a first acquisition means. It contains for example user identification information and/or a list of preferred recipients of the user 31.

It is especially preferred that a cashier scans at the cash register 6 or that the cash register 6 itself scans—reads—the key tag. By this way it is possible to associate items bought at the cash desk with shipment information, for example about the shipper.

A user (consumer) shops at a retail facility (shop) for a product and takes the product to a cash register 6. At the cash register 6 the user 31 can select an option that the product is shipped as shipment.

A payment of the goods and/or the shipment can be carried out in different ways, for example by utilizing a credit card or by using the key tag itself as a means for payment. This is especially useful if accounting information of the customer 31 is stored in the key tag 130.

In one exemplary embodiment of the present invention, it is useful to transmit information from the cash register 6 and/or the key tag 130 to the shipping pad 120.

This allows for example to transfer the information about items to be shipped to the shipping pad.

It is especially advantageous to design the shipping pad in a way that it contains means for using information contained in the key tag, for example a personalized list of pre-designed addressees of the user 31 as holder of the key tag 130.

Preferably the shipping pad is designed as a flat board which can be positioned easily near the cash register 6.

A usage of a display 121 of the shipping pad 120 allows a user to select shipment options.

It is especially preferred that the user makes a selection of one or more pre-defined addressees for shipments according to his pre-defined addresses.

In order to further facilitate the selection of one or more receiver of the shipment and/or to facilitate a selection of further shipment options, it is useful, if the display 121 is designed as a touch screen display. Options of these touch screen display can be selected by suitable means, for example a pen.

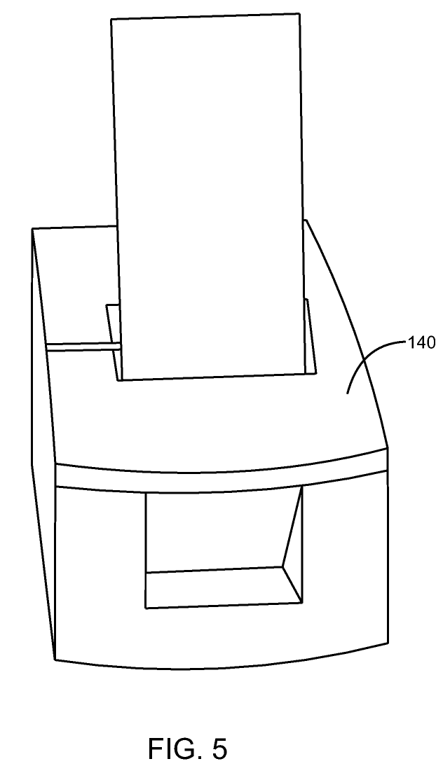

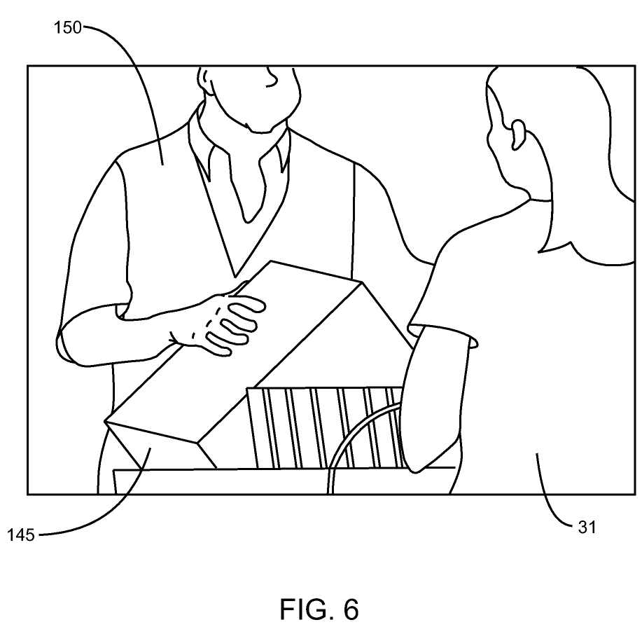

A waybill or a label are printed by a suitable means, for example a label printer 140 (FIG. 5). The label can be attached to a shipment like the shipment which is handed over from the user 31 to an associate 150 of a retailer which implements the shipping station to a retail facility e.g. a shop as shown in FIG. 6.

### LIST OF REFERENCE NUMERALS

1 display

2 terminal

3 phone

4 credit card reader

5 printer

6 cash register

7 scale

8 keyboard

9 cash register

10 shipping station

20 compartment

30 shipment

31 user

40 logistics service provider

50 acquisition means

60 verification means

80 second acquisition means

81 storage means

90 data base

100 notification component

110 central data processing unit

120 shipping pad

121 display of the shipping pad

130 key tag

140 label printer

145 shipment

150 associate

What is claimed is:

1. A shipping station, comprising:
a shipping pad; and
a cash register connected to the shipping pad by a data link.

2. The shipping station according to claim 1, wherein the shipping pad is adapted to read information from a key tag.

3. The shipping station according to claim 2, wherein the key tag contains information about a user.

4. The shipping station according to claim 2, wherein the key tag contains credit card information.

5. The shipping station according to claim 1, wherein the key tag contains accounting information.

6. The shipping station according to claim 1, comprising a printer connected to the shipping pad.

7. The shipping station according to claim 6, wherein the shipping pad is adapted to print a label on the printer.

8. The shipping station according to claim 1, comprising a display connected to the shipping pad.

9. The shipping station according to claim 1, comprising:
a scanner adapted to read from a key tag information entered by a first acquisition device and stored in the key tag; and
a second acquisition device adapted to acquire supplemental shipment information.

10. A method of shipping an item using a shipping station that includes a shipping pad and a cash register connected to the shipping pad by a data link, the method comprising:
acquiring data about a user and/or shipping preferences of the user by a first acquisition device separated from the shipping station;
acquiring shipment information for items at the shipping station; and
shipping the item according to data acquired by the first acquisition device and the shipment information.

11. The method according to claim 10, comprising reading the shipping information from a key tag.

12. The method according to claim 10, wherein the shipping information comprises credit card information.

13. The method according to claim 10, wherein the shipping information comprises accounting information.

14. The method according to claim 10, comprising printing a label containing the shipping information.

15. The method according to claim 10, comprising displaying the shipping information.

16. A logistics system that is adapted to facilitate the transport of shipments, the logistics system comprising:
a central control computer adapted to communicate with a first acquisition device that is adapted to acquire shipment information; and
a shipping station, located in a retail facility, the shipping station adapted to accept a deposit of shipments and to supplement the shipment information via a second acquisition device.

17. The logistics system according to claim 16, wherein the shipping station comprises a shipping pad and a cash register connected to the shipping pad by a data link.

18. The logistics system according to claim 16, wherein the shipping station is adapted to read information from a key tag.

19. The logistics system according to claim 16, comprising a printer connected to the shipping station.

20. The logistics system according to claim 16, comprising a display connected to the shipping station.
